(19) United States
(12) Patent Application Publication
(10) Pub. No.: US 2025/0070175 A1
(43) Pub. Date: Feb. 27, 2025

(54) SOLID-STATE BATTERY NEGATIVE ELECTRODE AND METHOD FOR MANUFACTURING THE SAME

(71) Applicants: Hyundai Motor Company, Seoul (KR); Kia Corporation, Seoul (KR)

(72) Inventors: Gyeong Jun Chung, Daejeon (KR); Seul Gi Choi, Changwon (KR); Sung Hoo Jung, Changwon (KR); Jong Jung Kim, Suwon (KR)

(21) Appl. No.: 18/626,063

(22) Filed: Apr. 3, 2024

(30) Foreign Application Priority Data
Aug. 22, 2023 (KR) 10-2023-0110162

(51) Int. Cl. H01M 4/62; H01M 4/02; H01M 4/04; H01M 4/38; H01M 4/583; H01M 10/0562

(52) U.S. Cl. CPC H01M 4/622; H01M 4/0404; H01M 4/386; H01M 4/583; H01M 10/0562; H01M 2004/027; H01M 2220/20

(57) ABSTRACT

Disclosed is a solid-state battery negative electrode including negative electrode active material particles containing silicon-coated graphite, and a rubber-based binder, wherein the rubber-based binder has a cross-linked structure formed through vulcanization.

### CROSS-REFERENCE TO RELATED APPLICATIONS

This application claims under 35 U.S.C. § 119 (a) the benefit of Korean Patent Application No. 10-2023-0110162 filed on Aug. 22, 2023, in the Korean Intellectual Property Office, the disclosure of which is incorporated herein by reference.

### BACKGROUND

### Technical Field

The present invention relates to a solid-state battery negative electrode including a vulcanized binder, and a method for manufacturing the same.

### Background

Chargeable/dischargeable secondary batteries have been used as large-capacity power storing batteries for electric vehicles, power storage systems, and the like, or as a compact high-performance energy source for portable electronic devices such as mobile phones, camcorders, and laptop computers. Lithium ion batteries are typical secondary batteries that are provided with larger capacity per unit area, lower self-discharge rate, and less memory effect than nickel-manganese batteries or nickel-cadmium batteries, thereby providing greater usability as a benefit.

However, the lithium ion batteries use a liquid electrolyte containing an organic solvent, thereby hardly providing stability of the batteries due to leakage from the use of highly volatile organic solvents, impact, and the like. Accordingly, to make sure that the lithium ion batteries are safe, research into solid-state batteries using a solid electrolyte instead of the liquid electrolyte has been actively ongoing.

Meanwhile, unlike typical lithium ion batteries, the solid-state batteries are beneficial in that the batteries are provided with a solid electrolyte, indicating no need of a separator and low heat generation, resulting in little risk of explosion. However, compared to the case of using the liquid electrolyte, the solid electrolyte has less chemical stability, lower price competitiveness, and lower energy density, and thus has not yet been commercially available.

To address such issues, research on solid-state batteries having improved energy density by applying silicon negative electrode active materials has been actively conducted. However, the solid-state batteries using silicon negative electrode active materials have limitations such as significant volume changes caused by repeated contraction and expansion during charging and discharging. The extreme volume changes weaken the degree of contact between constituent materials such as active material particles, conductive material particles, and electrolytes in an electrode, leading to deterioration in conductive network, charge and discharge performance, and capacity according to charge and discharge cycles. In addition, the volume changes cause silicon pulverization due to stress at an interface, and when a high output current is applied, an uneven volume change is caused to rapidly deteriorate battery life.

Accordingly, there is a need to develop a technology that may maintain excellent performance of the solid-state batteries by applying silicon negative electrode active materials and improve the lifespan of the solid-state batteries.

### SUMMARY

An embodiment of the present invention provides a solid-state battery negative electrode having improved battery life by applying a binder forming a cross-linked structure through vulcanization to enhance electrode adhesion and contact between a solid electrolyte and an active material, and a method for manufacturing the same.

The cross-linked structure may be formed into a three-dimensional network structure as chains of the rubber-based binder are connected.

The negative electrode active material particles may be connected through the rubber-based binder, and

The rubber-based binder may be connected through a linker containing —(S)ₙ—, n being an integer of 1 or greater.

The silicon-coated graphite may have a diameter of about 8 to about 20 μm.

The rubber-based binder may include butadiene rubber. In some embodiments, the rubber-based binder may include at least one selected from the group consisting of styrene-butadiene rubber (SBR), nitrile-butadiene rubber (NBR), butadiene rubber (BR), ethylene-propylene diene monomer (EPDM), styrene-butadiene-acrylonitrile (SBN), styrene-isoprene-styrene (SIS), styrene-butadiene-styrene (SBS), acrylic rubber (AR), and a mixture thereof.

The solid-state battery negative electrode may further include a solid electrolyte. The solid electrolyte may include a sulfide-based solid electrolyte.

According to an embodiment of the present disclosure, a method for manufacturing a solid-state battery negative electrode is provided. The method comprises applying, drying, and vulcanizing a slurry on a current collector, wherein the slurry comprises: a binder mixture comprising a rubber-based binder and a vulcanizing agent; negative electrode active material particles comprising silicon-coated graphite; and a solid electrolyte.

The binder mixture may include the rubber-based binder in an amount of 100 parts by weight and the vulcanizing agent in an amount of about 4.5 to 20 parts by weight.

The slurry may include the solid electrolyte in an amount of 100 parts by weight and the vulcanizing agent in an amount of about 0.2 to 1.5 parts by weight.

The vulcanizing agent may contain sulfur (S2) in an amount of 1 part by weight and a vulcanization accelerator in an amount of about 2 to 5 parts by weight. The vulcanization accelerator may include at least one selected from the group consisting of 2-mercapto benzo thiazole (MBT), tetra(iso-butyl)thiuram disulfide (TiBTD), zinc dibutyl dithiocarbamate (ZnDBC), N,N-diethylthiourea (DETU), caprolactam disulfide (CLD), N-cyclohexyl-2-benzothiazyl-sulfenamide, tetra methylthiuram disulfide, and a mixture thereof. The rubber-based binder may include at least one selected from the group consisting of styrene-butadiene rubber (SBR), nitrile-butadiene rubber (NBR), butadiene rubber (BR), ethylene-(EPDM), styrene-butadiene-acrylonitrile (SBN), styrene-propylene diene monomer isoprene-styrene (SIS), styrene-butadiene-styrene (SBS), acrylic rubber (AR), and a mixture thereof.

The solid electrolyte may include a sulfide-based solid electrolyte.

The slurry may be obtained by dry mixing the negative electrode active material particles and the solid electrolyte and further mixing the resultant with the binder mixture and a solvent.

The binder mixture may be prepared by stirring a mixture containing the rubber-based binder and the vulcanizing agent for about 12 to 36 hours.

The drying may be performed at about 80 to 100° C. for about 1 to 3 hours, and the vulcanizing may be performed at about 130 to 150° C. for about 1 to 30 minutes.

In some embodiments, a solid-state battery solid-state battery may include the solid-state battery negative electrode.

In some embodiments, a vehicle comprising the solid-state battery may be provided.

According to another embodiment of the present disclosure, there is provided a method for manufacturing a solid-state battery negative electrode including a step in which a binder mixture containing a rubber-based binder in an amount of 100 parts by weight and a vulcanizing agent in an amount of 4.5 to 20 parts by weight, and a slurry for a negative electrode including negative electrode active material particles and a solid electrolyte are applied, dried, and vulcanized.

### BRIEF DESCRIPTION OF THE DRAWINGS

The above and other embodiments, features and other advantages of the present disclosure will be more clearly understood from the following detailed description taken in conjunction with the accompanying drawings, in which:

FIG. 1 is a schematic view showing a solid-state battery negative electrode according to an embodiment of the present disclosure;

FIG. 2 is a schematic view showing a binder having a cross-linked structure formed through vulcanization; and

FIG. 3 is a graph showing the results of cycle characteristics evaluation for Examples 1 to 3 and Comparative Example 1.

### DETAILED DESCRIPTION OF THE PREFERRED EMBODIMENT

Hereinafter, a solid-state battery negative electrode and a method for manufacturing the same will be described in detail so that the present disclosure may be easily carried out by a person skill in the art to which the present disclosure pertains.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

A term “solid-state battery” as used herein refers to a rechargeable secondary battery that includes an electrolyte in a solid state, e.g., gel or polymer (cured), which may include an ionomer and other electrolytic components for transferring ions between the electrodes of the battery.

A solid-state battery negative electrode according to an embodiment of the present disclosure may include negative electrode active material particles containing silicon-coated graphite, and a rubber-based binder, and the rubber-based binder may have a cross-linked structure formed by vulcanization treatment.

While carbon used as a typical negative electrode active material may store 1 lithium ion per 6 carbon atoms when storing lithium ions, silicon contained in the silicon-coated graphite may store about 4.4 lithium ions per silicon atom when storing lithium ions. Accordingly, when using negative active material particles containing the silicon-coated graphite, solid-state batteries may have improved performance by improving energy density.

Meanwhile, silicon rapidly expands or contracts in volume during charging and discharging, which may weaken the degree of contact between materials in an electrode to cause a short circuit in a lithium ion path and pulverization of silicon. Therefore, the present disclosure intends to utilize a vulcanized binder to improve electrode adhesion and interfacial contact force between a solid electrolyte and an active material.

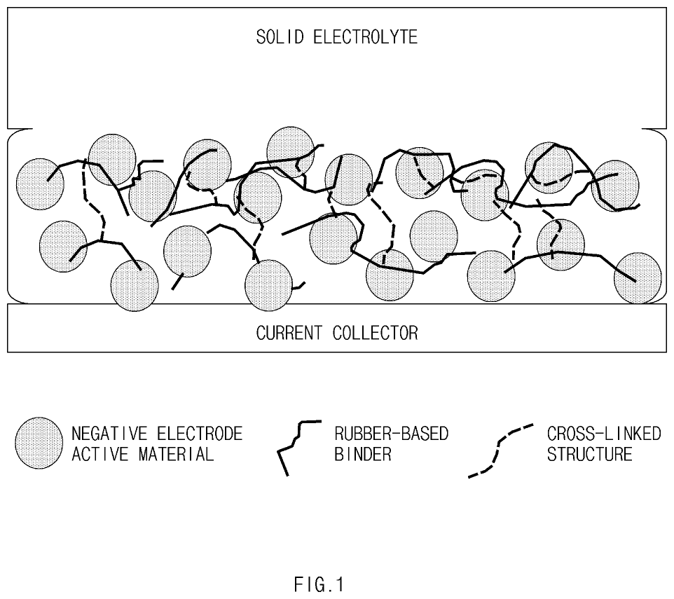

FIG. 1 is a schematic view showing a solid-state battery negative electrode according to an embodiment of the present disclosure.

Referring to FIG. 1, it is seen that the rubber-based binder connects the negative electrode active material particles, improves the bonding strength between the negative electrode active material and the solid electrolyte, and is distributed together with the negative electrode active material and the solid electrolyte so that a slurry containing the negative electrode active material and the solid electrolyte may be uniformly applied onto a current collector, and the rubber-based binder has a cross-linked structure formed through vulcanization.

The solid-state battery negative electrode according to an embodiment of the present disclosure may include a rubber-based binder, and the rubber-based binder may have a cross-linked structure formed through vulcanization. The cross-linked structure may be formed into a three-dimensional network structure as chains of the rubber-based binder are connected. In this case, the forming of a three-dimensional network structure indicates a structure in which atoms included in a chain constituting the rubber-based binder and atoms included in another chain constituting the rubber-based binder are connected through a sulfur atom (S)-containing linker.

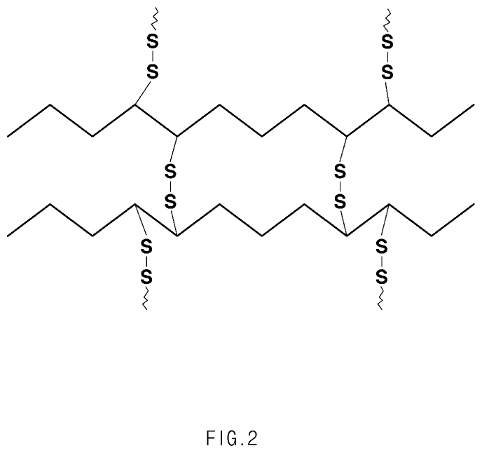

FIG. 2 is a schematic view showing a binder having a cross-linked structure formed through vulcanization.

Referring to FIG. 2, it is seen that the chains of the rubber-based binder are connected through linkers by vulcanization to form a three-dimensional network structure.

Meanwhile, the rubber-based binder connecting the negative electrode active material particles may be connected through a linker containing —(S)n-. In this case, n is an integer of 1 or greater. That is, the linker may include one sulfur atom or a plurality of sulfur atoms.

The silicon-coated graphite may have a diameter of 8 to 20 μm, preferably 8 to 10 μm. When the silicon-coated graphite having a diameter in the above range is used, better charge/discharge capacity may be obtained to improve initial efficiency and charging performance.

A rubber-based binder as referred to herein may include a variety of materials. The rubber-based binder may include, for example, a styrene-butadiene rubber, an acrylated styrene-butadiene rubber, an acrylonitrile-butadiene rubber, an acrylonitrile-butadiene-styrene rubber, an acrylic rubber, a butyl rubber, a fluorine rubber, or a combination thereof. In aspects, a rubber based binder may include one or more of a natural rubber, butyl-based rubber, bromo-butyl-based rubber, chlorinated butyl-based rubber, styrene isoprene-based rubber, styrene-ethylene-butylene-styrene-based rubber, acrylonitrile-butadiene-styrene-based rubber, polybutadiene-based rubber, nitrile butadiene-based rubber, styrene butadiene-based rubber, styrene butadiene styrene-based rubber (SBS) and ethylene propylene diene monomer (EPDM)-based rubber.

In certain preferred aspects, the rubber-based binder may include at least one selected from the group consisting of styrene-butadiene rubber (SBR), nitrile-butadiene rubber (NBR), butadiene rubber (BR), ethylene-propylene diene monomer (EPDM), styrene-butadiene-acrylonitrile (SBN), styrene-isoprene-styrene (SIS), styrene-butadiene-styrene (SBS), acrylic rubber (AR), and a mixture thereof. Preferably, the rubber-based binder may include at least one selected from the group consisting of styrene butadiene rubber (SBR), nitrile butadiene rubber (NBR), butadiene rubber (BR), and a mixture thereof.

A rubber-based binder suitably may comprise one or more distinct materials. At least a portion of the rubber-based binder will comprise a material viewed as a rubber-type material, such as one or more of the above noted materials. For instance, in aspects, at least 10, 20, 30, 40, 50, 60, 70, 80, 90, 95, 98 or 99 weight percent of the total weight of the rubber-based binder component will be composed of one or more rubber-type materials such as one or more of those identified above.

The solid-state battery negative electrode according to an embodiment of the present disclosure may further include a solid electrolyte. Accordingly, compared to secondary batteries using liquid electrolytes, sulfur elution may be suppressed to further improve electrode adhesion and interfacial contact force between the solid electrolyte and the active material.

The solid electrolyte may include a sulfide-based solid electrolyte. The solid electrolyte may be in the form of powder or molded article. The solid electrolyte having the form of a molded article may be in the form of, for example, a pellet, sheet, or thin film, but is not necessarily limited to thereto, and may be in various forms depending on the intended use.

Then, a method for manufacturing a solid-state battery negative electrode according to another embodiment of the present disclosure will be described in detail.

The method for manufacturing a solid-state battery negative electrode according to an embodiment of the present disclosure may include a step in which a binder mixture containing a rubber-based binder in an amount of 100 parts by weight and a vulcanizing agent in an amount of 4.5 to 20 parts by weight, and a slurry for a negative electrode including negative electrode active material particles and a solid electrolyte are applied, dried, and vulcanized.

The binder mixture may include the rubber-based binder in an amount of 100 parts by weight and the vulcanizing agent in an amount of 4.5 to 20 parts by weight, preferably 100 parts by weight and 5 to 20 parts by weight, and more preferably 100 parts by weight and 10 to 20 parts by weight, respectively.

The inclusion of a rubber-based binder and a vulcanizing agent in the above range may improve electrode adhesion and interfacial contact force between the solid electrolyte and the active material, increase mechanical properties, and further improve the lifespan of solid-state batteries through excellent cycle characteristics.

The slurry for a negative electrode may include 100 parts by weight of a solid electrolyte and 0.2 to 1.5 parts by weight of a vulcanizing agent, preferably 100 parts by weight of a solid electrolyte and 0.29 to 1.5 parts by weight of a vulcanizing agent, more preferably 100 parts by weight of a solid electrolyte and 0.29 to 1.17 parts by weight of a vulcanizing agent, even more preferably 100 parts by weight of a solid electrolyte and 0.59 to 1.5 parts by weight of a vulcanizing agent, most preferably 100 parts by weight of a solid electrolyte and 0.59 to 1.17 parts by weight of a vulcanizing agent.

The inclusion of a solid electrolyte and a vulcanizing agent in the above range may allow the negative electrode slurry to be uniformly applied onto a current collector and may improve electrode adhesion, resulting in improved lifespan of solid-state batteries.

The vulcanizing agent may contain 1 part by weight of sulfur (S₂) and 2 to 5 parts by weight of a vulcanization accelerator, preferably 1 part by weight of sulfur (S₂) and 2 to 4 parts by weight of a vulcanization accelerator, more preferably 1 part by weight of sulfur (S₂) and 3 to 4 parts by weight of a vulcanization accelerator.

The inclusion of sulfur and a vulcanization accelerator in the above range, a cross-linked structure connecting chains of the rubber-based binder may be sufficiently formed, and also brittleness caused by excessive cross-linking reactions may be prevented.

The vulcanization accelerator may be added to promote the cross-linking of sulfur between chains of the rubber-based binder, and may include at least one selected from the group consisting of 2-mercapto benzo thiazole (MBT), tetra(iso-butyl)thiuram disulfide (TiBTD), zinc dibutyl dithiocarbamate (ZnDBC), N,N-diethylthiourea (DETU), caprolactam disulfide (CLD), N-cyclohexyl-2-benzothiazyl-sulfenamide, tetra methylthiuram disulfide, and a mixture thereof.

The rubber-based binder may include at least one selected from the group consisting of styrene-butadiene rubber (SBR), nitrile-butadiene rubber (NBR), butadiene rubber (BR), ethylene-propylene diene monomer (EPDM), styrene-butadiene-acrylonitrile (SBN), styrene-isoprene-styrene (SIS), styrene-butadiene-styrene (SBS), acrylic rubber (AR), and a mixture thereof. Preferably, the rubber-based binder may include at least one selected from the group consisting of styrene butadiene rubber (SBR), nitrile butadiene rubber (NBR), butadiene rubber (BR), and a mixture thereof.

In addition, the solid electrolyte may include a sulfide-based solid electrolyte and may be in the form of powder or molded article. The solid electrolyte having the form of a molded article may be in the form of, for example, a pellet, sheet, or thin film, but is not necessarily limited to thereto, and may be in various forms depending on the intended use.

The slurry for a negative electrode may be obtained by dry mixing the negative electrode active material particles and the solid electrolyte and further mixing the resultant with the binder mixture and a solvent. In this case, the mixing may be performed using a planetary disperser (P/D) mixer to ensure uniformity, but is not limited thereto.

For uniform mixing, the binder mixture may be prepared by stirring a mixture containing the rubber-based binder and the vulcanizing agent for 12 to 36 hours, preferably stirring the mixture for 24 to 36 hours, more preferably stirring the mixture for 24 hours.

The drying can be performed at 80 to 100° C. for 1 to 3 hours, preferably at 90° C. for 1 to 2 hours, and vacuum drying (V/D) may be performed to reduce the process time, but the embodiment of the present disclosure is not limited thereto.

The vulcanizing may be performed at 130 to 150° C. for 1 to 30 minutes, preferably at 140° C. for 20 to 30 minutes. The vulcanizing performed in the above vulcanization temperature and time range may sufficiently form a cross-linked structure and also prevent brittleness caused by excessive cross-linking reactions.

Hereinafter, the present disclosure will be described in more detail through Examples. However, these Examples are provided to assist understanding of the present disclosure, and the scope of the present disclosure is not limited to the Examples in any sense.

### <Example 1> Manufacture of Solid-State Battery Negative Electrode 1

A binder mixture containing a rubber-based binder containing butadiene rubber (BR) in an amount of 100 parts by weight and a vulcanizing agent in an amount of 20 parts by weight was stirred for 24 hours through a P/D (planetary disperser) mixer to prepare a binder mixture. In this case, the vulcanizing agent included sulfur (S₂) in an amount of 1 part by weight and a vulcanization accelerator in an amount of 3 parts by weight, and 2-mercaptobenzothiazole (MBT) was used as the vulcanization accelerator.

Thereafter, negative electrode active material particles and a sulfide-based solid electrolyte were dry mixed through the P/D (planetary disperser) mixer, and then a solvent was further mixed with the binder mixture to prepare a negative electrode slurry. In this case, silicon-coated graphite having an average diameter (D₅₀) of 9 μm was used as the negative electrode active material particles, and butyl butyrate was used as the solvent. In addition, the solid electrolyte and the vulcanizing agent were included in a ratio of 100 parts by weight of the solid electrolyte and 1.17 parts by weight of the vulcanizing agent.

Thereafter, the negative electrode slurry was applied onto a current collector, and then vacuum dried (V/D) at 90° C. for 2 hours, and vulcanized at 140° C. for 20 minutes to prepare a solid-state battery negative electrode.

### <Example 2> Manufacture of Solid-State Battery Negative Electrode 2

A solid-state battery negative electrode was manufactured in the same manner as in Example 1, except that a binder mixture containing a rubber-based binder in an amount of 100 parts by weight and a vulcanizing agent in an amount of 5 parts by weight was used, and a solid electrolyte was included in an amount of 100 parts by weight and the vulcanizing agent was included in an amount of 0.29 parts by weight.

### <Example 3> Manufacture of Solid-State Battery Negative Electrode 3

A solid-state battery negative electrode was manufactured in the same manner as in Example 1, except that a binder mixture containing a rubber-based binder in an amount of 100 parts by weight and a vulcanizing agent in an amount of 10 parts by weight was used, and a solid electrolyte was included in an amount of 100 parts by weight and the vulcanizing agent was included in an amount of 0.59 parts by weight.

### <Comparative Example 1> Manufacture of Solid-State Battery Negative Electrode 4

A solid-state battery negative electrode was manufactured in the same manner as in Example 1, except that no vulcanizing agent was added.

### <Experimental Example 1> Evaluation of Electrode Adhesion of Solid-State Battery Negative Electrode

For evaluation on electrode adhesion of solid-state battery negative electrodes, 180° peel strength was measured for solid-state battery negative electrodes according to Examples 1 to 3 and Comparative Example 1, using a universal testing machine (UTM). In this case, the 180° peel strength was given as an average peel strength measured in a section having a displacement of 20 to 50 mm.

In the 180° peel strength evaluation, Example 1 was observed to have an adhesion of 0.02 gf/mm. 1.21 gf/mm, Example 2 was observed to have an adhesion of 0.02 gf/mm. 0.28 gf/mm, and Example 3 was observed to have an adhesion of 0.02 gf/mm. 1.09 gf/mm, while Comparative Example 1 was observed to have an adhesion of 0.02 gf/mm. That is, it was observed that Examples 1 to 3, which utilized the rubber-based binder having a cross-linked structure formed through vulcanization had greater electrode adhesion than Comparative Example 1 without a vulcanizing agent.

### <Experimental Example 2> Evaluation on Cycle Characteristics of Solid-State Battery Negative Electrode

For evaluation on the cycle characteristics of solid-state battery negative electrodes, Table 1 below shows the discharge capacity, charge capacity, and capacity retention after 20 cycles of charge and discharge of Examples 1 to 3 and Comparative Example 1.

TABLE 1

| | Discharge capacity | Charge capacity | Capacity |
|---|---|---|---|
| | (mAh/g) | (mAh/g) | retention (%) |
| Example 1 | 179.0 | 181.1 | 94.1 |
| Example 2 | 158.2 | 168.3 | 93.8 |
| Example 3 | 163.0 | 171.5 | 92.1 |
| Comparative | 154.5 | 159.8 | 90.7 |
| Example 1 | | | |

Referring to Table 1, it is seen that Examples 1 to 3, which utilized the rubber-based binder having a cross-linked structure formed through vulcanization, had improving electrode adhesion and interfacial contact force between the solid electrolyte and the active material, resulting in improved battery life, but Comparative Example 1, in which no vulcanizing agent was added, had relatively less battery life.

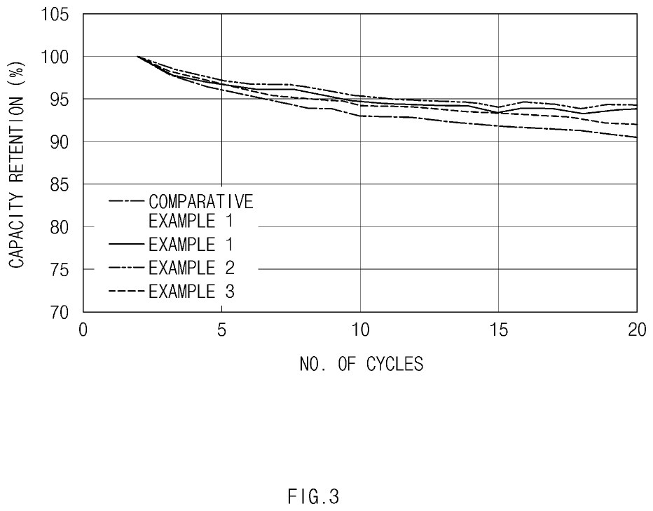

FIG. 3 is a graph showing the results of cycle characteristics evaluation for Examples 1 to 3 and Comparative Example 1.

Referring to FIG. 3, as described above, it is seen that Examples 1 to 3, which utilized the rubber-based binder having a cross-linked structure formed through vulcanization, had less reduction in capacity retention according to the number of cycles than Comparative Example 1.

What is claimed is:

1. A solid-state battery negative electrode comprising:
negative electrode active material particles comprising silicon-coated graphite; and
a rubber-based binder,
wherein the rubber-based binder has a cross-linked structure.

2. The solid-state battery negative electrode of claim 1 wherein the cross-linked structure of the rubber-based binder is produced by vulcanization.

3. The solid-state battery negative electrode of claim 1, wherein the cross-linked structure is formed into a three-dimensional network structure as chains of the rubber-based binder are connected.

4. The solid-state battery negative electrode of claim 1, wherein the negative electrode active material particles are connected through the rubber-based binder, and
the rubber-based binder is connected through a linker containing —(S)ₙ—, n being an integer of 1 or greater.

5. The solid-state battery negative electrode of claim 1, wherein the silicon-coated graphite has a diameter of about 8 to about 20 μm.

6. The solid-state battery negative electrode of claim 1, wherein the rubber-based binder comprises butadiene rubber.

7. The solid-state battery negative electrode of claim 1, wherein the rubber-based binder comprises at least one selected from the group consisting of styrene-butadiene rubber (SBR), nitrile-butadiene rubber (NBR), butadiene rubber (BR), ethylene-propylene diene monomer (EPDM), styrene-butadiene-acrylonitrile (SBN), styrene-isoprene-styrene (SIS), styrene-butadiene-styrene (SBS), acrylic rubber (AR), and a mixture thereof.

8. The solid-state battery negative electrode of claim 1, further comprising a solid electrolyte.

9. The solid-state battery negative electrode of claim 8, wherein the solid electrolyte comprises a sulfide-based solid electrolyte.

10. A method for manufacturing a solid-state battery negative electrode, the method comprising:
applying, drying, and vulcanizing a slurry on a current collector,
wherein the slurry comprises:
a binder mixture comprising a rubber-based binder and a vulcanizing agent,
negative electrode active material particles comprising silicon-coated graphite, and
a solid electrolyte.

11. The method of claim 10, wherein the binder mixture comprises the rubber-based binder in an amount of 100 parts by weight and the vulcanizing agent in an amount of about 4.5 to 20 parts by weight.

12. The method of claim 10, wherein the slurry comprises the solid electrolyte in an amount of 100 parts by weight and the vulcanizing agent in an amount of about 0.2 to 1.5 parts by weight.

13. The method of claim 10, wherein the vulcanizing agent contains sulfur (S₂) in an amount of 1 part by weight and a vulcanization accelerator in an amount of about 2 to 5 parts by weight.

14. The method of claim 13, wherein the vulcanization accelerator comprises at least one selected from the group consisting of 2-mercapto benzo thiazole (MBT), tetra(iso-butyl)thiuram disulfide (TiBTD), zinc dibutyl dithiocarbamate (ZnDBC), N,N-diethylthiourea (DETU), caprolactam disulfide (CLD), N-cyclohexyl-2-benzothiazyl-sulfenamide, tetra methylthiuram disulfide, and a mixture thereof.

15. The method of claim 10, wherein the rubber-based binder comprises at least one selected from the group consisting of styrene-butadiene rubber (SBR), nitrile-butadiene rubber (NBR), butadiene rubber (BR), ethylene-propylene diene monomer (EPDM), styrene-butadiene-acrylonitrile (SBN), styrene-isoprene-styrene (SIS), styrene-butadiene-styrene (SBS), acrylic rubber (AR), and a mixture thereof.

16. The method of claim 10, wherein the solid electrolyte comprises a sulfide-based solid electrolyte.

17. The method of claim 10, wherein the slurry is obtained by dry mixing the negative electrode active material particles and the solid electrolyte and further mixing the resultant with the binder mixture and a solvent.

18. The method of claim 10, wherein the binder mixture is prepared by stirring a mixture containing the rubber-based binder and the vulcanizing agent for about 12 to 36 hours.

19. A solid-state battery comprising the solid-state battery negative electrode of claim 1.

20. A vehicle comprising the solid-state battery of claim 19.
